(19) United States
(12) Patent Application Publication
(10) Pub. No.: US 2010/0071036 A1
(43) Pub. Date: Mar. 18, 2010

(54) METHOD AND APPARATUS FOR REDISTRIBUTION SYSTEM

(75) Inventors: Matthew Jason Rea, Sachse, TX (US); Mark Fry, Dallas, TX (US)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 12/212,027

(22) Filed: Sep. 17, 2008

(51) Int. Cl. H04L 9/32

(52) U.S. Cl. 726/4

(57) ABSTRACT

A method and apparatus for distributing at least one of documents or data to their respective owners. The method comprising receiving at least one of the documents or the data from users, associating the at least one of the documents or the data with users' login, wherein the users are owners of their respective at least one documents or data, and simultaneously scheduling the distribution of the at least one of the documents or the data to their respective owners.

### BACKGROUND OF THE INVENTION

1. Field of the Invention

Embodiments of the present invention generally relate to a method and apparatus for redistribution system. More specifically, a method and apparatus for distributing documents/data.

2. Description of the Related Art

The use of technology has expanded into the classroom. Many classes are taught online and/or utilize the internet for the submission and retrieval of homework. Many teachers utilize the internet to distribute class documents, homework and exams. In many instances, students also use the internet to submit their homework or exams.

However, it is necessary for the receiver, such as, a teacher, to maintain a record identifying the source of such homework. The teacher usually has to redistribute the documents/data, to their respective owners, one at a time. In addition, if a document does not contain the owner's name, the teacher usually has to research the source of such document.

In other words, teachers do not have a system through which documents can easily be collected electronically from a specific student and redistributed to the same student at a later time in a single action, without the need to redistribute the document/data to each student separately.

Therefore, there is a need for a method and apparatus for an enhanced such a distribution system.

### SUMMARY OF THE INVENTION

Embodiments of the present invention relate to a method and apparatus for distributing at least one of documents or data to their respective owners. The method comprising receiving at least one of the documents or the data from users, associating the at least one of the documents or the data with users' login, wherein the users are owners of their respective at least one documents or data, and simultaneously scheduling the distribution of the at least one of the documents or the data to their respective owners.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is an exemplary embodiment of a distribution system utilizing a network in accordance with the present invention;

FIG. 2 is an exemplary embodiment of a block diagram of an distribution apparatus in accordance with the present invention;

FIG. 3 is an exemplary embodiment of a block diagram of an user apparatus in accordance with the present invention;

FIG. 4 is a flow diagram depicting an exemplary embodiment of a user method in accordance with the present invention; and

FIG. 5 is a flow diagram depicting an exemplary embodiment of a distribution method in accordance with the present invention.

### DETAILED DESCRIPTION

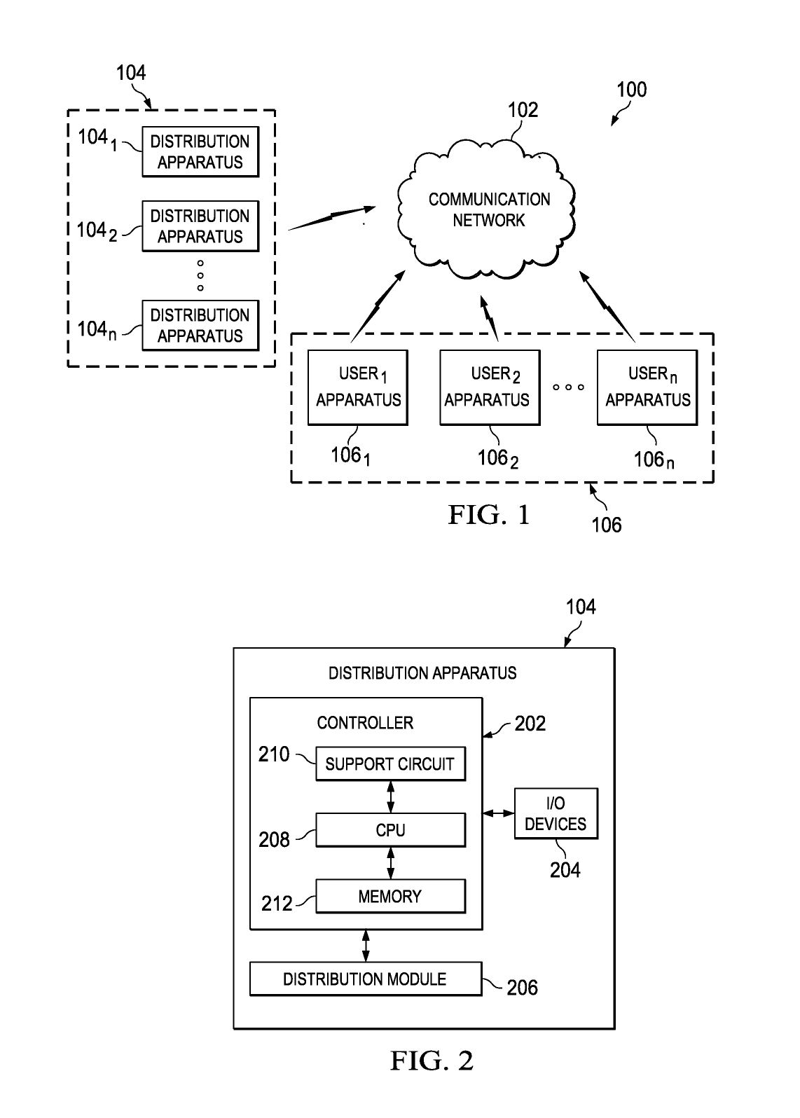

FIG. 1 is an exemplary embodiment of a distribution system 100 utilizing a network in accordance with the present invention. One skilled in the art will appreciate that distribution system 100 may or may not contain all the components listed below.

The distribution system 100 includes a communication network 102, a distribution apparatus 104₁, 104₂ . . . 104ₙ (hereon after referred to as 104) and user apparatus 106₁, 106₂ . . . 106ₙ (hereon after referred to as 106). The communication network 102 may be any conventional network, such as, an Ethernet network, a fiber channel network, or a wide area network (WAN) that provides either a direct or indirect (e.g., Internet via a wired or wireless connection, or public switched telephone network (PSTN)) connection between the users 106 and the distribution system 100.

The distribution apparatus 104 communicates with the user apparatus 106 via the communication network 102. The distribution apparatus 104 is described in detail in FIG. 2. The distribution apparatus 104 presented in FIG. 1 is a stand-alone apparatus. Other embodiments of the present invention include incorporating distribution apparatus 104 into a larger system, such as, school system and/or a teacher network. The distribution apparatus 104 may be a handheld device, laptop, personal computer and the like.

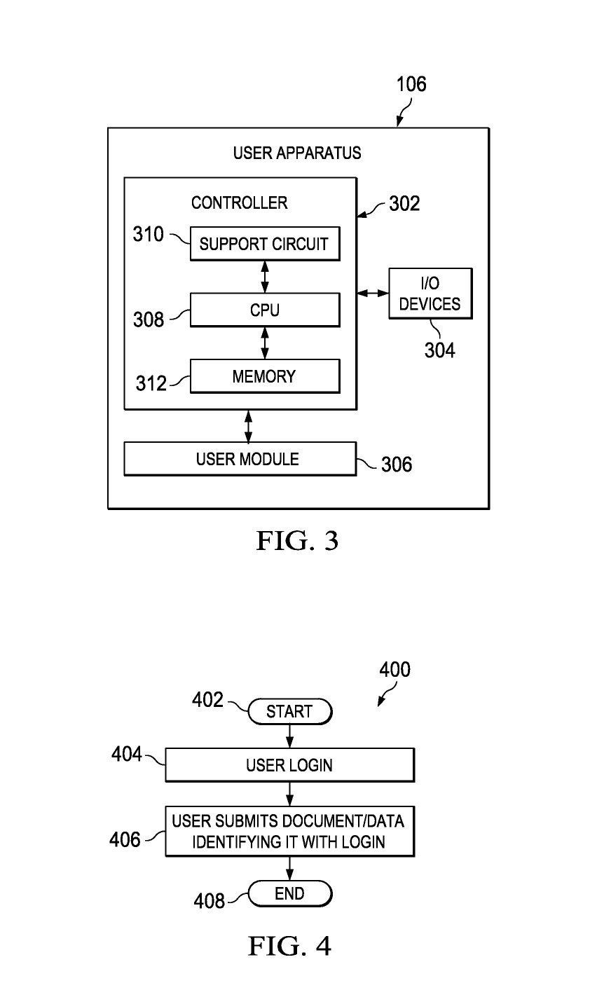

The user apparatus 106 communicate with the distribution apparatus 104 via the communication network 102. The user apparatus 106 is described in detail in FIG. 3. The user apparatus 106 presented in FIG. 1 is a stand-alone apparatus. Other embodiments of the present invention include incorporating user apparatus 106 into a larger system, such as, school system and/or a student network. The user apparatus 106 is preferably a handheld device; however, maybe a computer device, laptop, personal computer, calculator and/or the like.

It should be noted that the distribution system 100 may include any number of communication network 102, distribution apparatus 104 and users 106. In addition, the distribution system 100 and all its components are not limited to a specific operating system, but may be adapted to run on multiple operating systems, such as, Linux and Microsoft Windows.

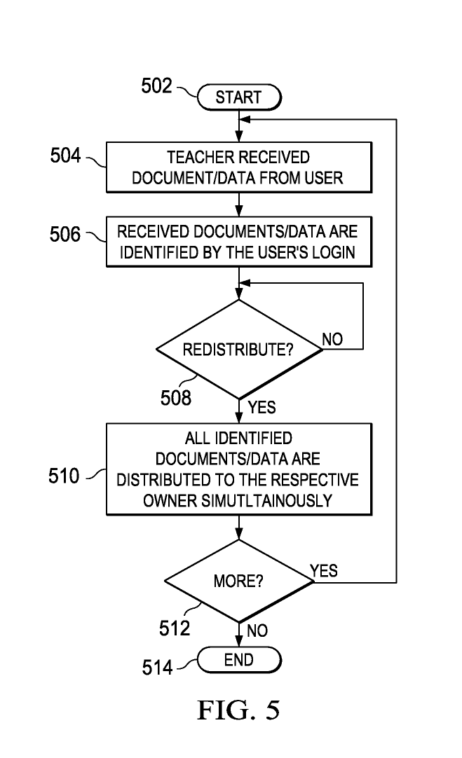

The distribution system 100 facilitates the exchange of data and/or documents between the distribution apparatus 104 and the user apparatus 106. The distribution apparatus 104 maybe utilized by a teacher to transmit and receive homework, exams and the like. The distribution system 100 assists a teacher, for example, in receiving data and/or documents and automatically redistributing the data and/or documents to the respective document/data owner in one step. The method of distribution is better described in FIG. 5.

FIG. 2 is an exemplary embodiment of a block diagram of a distribution apparatus 104 of FIG. 1, in accordance with the present invention. The distribution apparatus 104 may function in a variety of computing environments; such as, a distributed computer system, a centralized computer system, a stand alone computer system, calculator, handheld device or the like. One skilled in the art will appreciate that distribution apparatus 104 may or may not contain all the components listed below.

The distribution apparatus 104 includes a controller 202, an input/output (I/O) device 204 and a distribution module 206. The controller 202 includes a central processing unit (CPU) 208, support circuit 210 and memory 212. The CPU 208 may comprise one or more conventionally available microprocessors. The microprocessor may be an application specific integrated circuit (ASIC). The support circuits 210 are well known circuits used to promote functionality of the CPU 208. Such circuits include, but are not limited to, a cache, power supplies, clock circuits, input/output (I/O) circuits and the like.

The memory 212 may comprise random access memory, read only memory, removable disk memory, flash memory, and various combinations of these types of memory. The memory 212 is a computer readable medium, which is sometimes referred to main memory and may, in part, be used as cache memory or buffer memory. The memory 212 may store an operating system (OS), database software, various forms of application software, and the like.

The I/O device 204 may be placed any where in the distribution system 100 (FIG. 1) or the distribution apparatus 104. As such, the I/O device 204 may be a separate device coupled, remotely communicating with or attached to the distribution apparatus 104. The I/O device 204 may be an audio, video, graphical, printer, touch screen, a keypad, LCD, and/or LED display.

The I/O device 204 may be used for data/document entry, retrieval and/or inputting. The distribution apparatus 104 may include any number of I/O devices 102. For example, the distribution apparatus 104 may allow multiple individuals, such as, teachers, to simultaneously utilize the same distribution apparatus 104. The individuals using the distribution apparatus 104 may be in the same location or different locations.

Distribution module allows the teacher, for example, to collect an assignment from the user of the distribution apparatus 104, such as, a student. At a later time, the teacher may redistribute the student's document/data in one action. In other words, the teacher would not have to send each file to each student separately. The method utilized in the distribution module 104 is described in detail in FIG. 5.

FIG. 3 is an exemplary embodiment of a block diagram of a user apparatus 106 of FIG. 1, in accordance with the present invention. The user apparatus 106 may function in a variety of computing environments; such as, a distributed computer system, a centralized computer system, a stand alone computer system, calculator, handheld device or the like. One skilled in the art will appreciate that user apparatus 106 may or may not contain all the components listed below.

The user apparatus 106 includes a controller 302, input/output (I/O) device 304 and user module 306. The controller 302 includes a central processing unit (CPU) 308, support circuit 310 and memory 312. The CPU 308 may comprise one or more conventionally available microprocessors. The microprocessor may be an application specific integrated circuit (ASIC). The support circuits 310 are well known circuits used to promote functionality of the CPU 308. Such circuits include, but are not limited to, a cache, power supplies, clock circuits, input/output (I/O) circuits and the like.

The memory 312 may comprise random access memory, read only memory, removable disk memory, flash memory, and various combinations of these types of memory. The memory 312 is a computer readable medium, which is sometimes referred to main memory and may, in part, be used as cache memory or buffer memory. The memory 312 may store an operating system (OS), database software, various forms of application software, and the like.

The I/O device 304 may be placed any where in the distribution system 100 (FIG. 1) or the user apparatus 106. As such, the I/O device 304 may be a separate device coupled, remotely communicating with or attached to the user apparatus 106. The I/O device 304 may be an audio, video, graphical, printer, touch screen, a keypad, LCD, and/or LED display.

The I/O device 304 may be used for data/document entry, retrieval and/or inputting. The user apparatus 106 may include any number of I/O devices 102. For example, the user apparatus 106 may allow multiple users, such as, students, to simultaneously utilize the same user apparatus 106; the users may be in the same location or different locations.

User module 306 is any application that allows a user to submit or create data/documents. The user method is better described in FIG. 4. The user module 306 communicates with the distribution apparatus 104 (FIG. 1). The user module 306 may be able to directly communicate with the network communication 102 (FIG. 1) and/or the distribution apparatus 104.

FIG. 4 is a flow diagram depicting an exemplary embodiment of a user method 400 in accordance with the present invention. The user method 400 starts at step 402 at proceeds to step 404. At step 404, a user of a user apparatus 106 (FIG. 1) logs-in to a session. The user may find a request from the distribution apparatus requesting documents and/or data. The request may specify different documents/data from different students. At step 406, the user submits document/data. The document/data are identified by the log-in of the user, such as, IP number, login name, login email and the like. The user method 400 ends at step 408.

FIG. 5 is a flow diagram depicting an exemplary embodiment of an education method 500 in accordance with the present invention. The education method 500 starts at step 502 and proceeds to step 504. In this example, an distribution apparatus 104 (FIG. 1) is being used by a teacher. At step 504, the teacher receives documents/data from the users of the user apparatus 106 (FIG. 1), such as, students. The teacher may have submitted requests to students logged into a session requesting specific filed be submitted. The teacher received files may appear at the teacher's distribution apparatus. At step 506, the received documents are identified by the log-in of the user of the user apparatus 106, such as, IP number, login name, login email and the like. At step 508, if the teacher decides to redistribute the documents/data to their respective owner, the education method 500 proceeds to step 510. Otherwise, the education method 500 returns to step 508. At step 510, the documents/data are distributed to their respective owners simultaneously. The owners are identified by the login attached to the documents/data. It should be understood that teacher is able to redistribute the documents/data in one step. However, the system may distribute such documents/data simultaneously or at different times. It should also be understood that the teacher may receive more documents/data throughout the method. If there are more documents/data the teacher wishes to receive or distribute, the education method 500 returns to step 504. Otherwise, the education method 500 ends at step 514.

While the foregoing is directed to embodiments of the present invention, other and further embodiments of the invention may be devised without departing from the basic scope thereof, and the scope thereof is determined by the claims that follow.

What is claimed is:

1. A method for distributing at least one of documents or data to their respective owners, comprising:
receiving at least one of the documents or the data from users;
associating the at least one of the documents or the data with users' login, wherein the users are owners of their respective at least one documents or data; and
simultaneously scheduling the distribution of the at least one of the documents or the data to their respective owners.

2. The method of claim 1 further comprising distributing the at least one of the documents or the data to their respective owner.

3. The method of claim 2, wherein the scheduling and the distribution of the at least one of documents or data to their respective owner occurs simultaneously.

4. The method of claim 1, wherein the method is utilized by a teacher.

5. The method of claim 1 further comprising the users receiving a request to distribute the at least one of documents or data.

6. The method of claim 5, wherein the request specifies at least one of a session or the at least one of the document or the data.

7. The method of claim 5, wherein the request is different for each user.

8. A distributing apparatus for distributing at least one of documents or data, comprising:
means for receiving the at least one of the documents or the data from users;
means for associating the at least one of the documents or the data with users' login, wherein the users are owners of their respective the at least one the documents or the data; and
means for simultaneously scheduling the distribution of the at least one of the documents or the data to their respective owners.

9. The method of claim 8 further comprising a means for distributing the at least one of the documents or the data to their respective owner.

10. The method of claim 9, wherein the means for scheduling and the means for distributing the at least one of the documents or the data to their respective owner are combined.

11. The method of claim 8, wherein the distribution apparatus is utilized by a teacher.

12. The method of claim 8 further comprising a means for receiving a request to distribute the at least one of the documents or the data.

13. The method of claim 12, wherein the request specifies at least one of a session or the at least one of the document or the data.

14. The method of claim 12, wherein the request is different for each user.

15. A computer readable medium comprising software that, when executed by a processor, causes the processor to perform a method comprising:
receiving at least one of documents or data from users;
associating the at least one of documents or data with users' login, wherein the users are owners of their respective at least one documents or data; and
simultaneously scheduling the distribution of the at least one of documents or data to their respective owners.

16. The method of claim 15 further comprising distributing the at least one of documents or data to their respective owner.

17. The method of claim 16, wherein the scheduling and the distribution of the at least one of documents or data to their respective owner occurs simultaneously.

18. The method of claim 15, wherein the method is utilized by a teacher.

19. The method of claim 15 further comprising the users receiving a request to distribute the at least one of documents or data.

20. The method of claim 19, wherein the request specifies at least one of a session or the at least one of the document or the data.

21. The method of claim 19, wherein the request is different for each user.
